(19) United States
(12) Patent Application Publication
(10) Pub. No.: US 2014/0170586 A1
(43) Pub. Date: Jun. 19, 2014

(54) CONNECTOR FOR ORTHODONTIC ARCH-WIRES

(71) Applicant: Daniele CANTARELLA, NERVESA DELLA BATTAGLIA (IT)

(72) Inventor: Daniele CANTARELLA, NERVESA DELLA BATTAGLIA (IT)

(21) Appl. No.: 13/772,645

(22) Filed: Feb. 21, 2013

(30) Foreign Application Priority Data
Dec. 19, 2012 (IT) TV2012U000059

(51) Int. Cl. A61C 7/12

(52) U.S. Cl. CPC A61C 7/12
USPC 433/22

(57) ABSTRACT

A connector for orthodontic arch-wires which comprises a body that has two axial seats, each for an end of the wires that can be inserted therein, the two seats being divided by a partition that protrudes inside the body, a grip element for an elastically deformable element being able to be associated with the body.

The present invention relates to a connector for orthodontic arch-wires.

### BACKGROUND OF THE INVENTION

In orthodontics there is sometimes the need to mutually join orthodontic wires (also known as arch-wires) that are usually different because they have cross-sections with different shapes or dimensions or because they are made of different materials.

An example of an orthodontic arch-wire is described in EP1959858B1, which claims an orthodontic appliance comprising a differential wire, such wire comprising an anterior segment with a large cross-section area and two posterior segments with a smaller cross-section area, said appliance comprising anterior brackets to be attached to the incisors and posterior brackets to be attached to canines, premolars and molars, wherein the anterior segment is adapted for the insertion and complete filling of the slots of the anterior brackets and the posterior segments are adapted for insertion in the slots of the posterior brackets, so that the small cross-sectional area of the posterior segments allows the wire to slide along the posterior brackets.

Moreover, the anterior segment is more rigid than the posterior segments, and the three segments have a preferably rectangular cross-section shape.

One problem observed in the background art is to be able to provide a joint between the two wires so that the two wires are on the same horizontal, vertical and frontal planes; in other words, the central axis of one wire must continue in the central axis of the adjacent wire.

In other words, the two wires must be concentric.

It is possible to join two wires to each other by pairing them on the horizontal or vertical plane and then soldering them to each other or locking them to each other by means of connectors that can be clamped.

However, these solutions have drawbacks, since they inevitably arrange at the end of the work, due to the dimensions involved of the components, the orthodontic wires on different planes, so that a lack of leveling or an axial offset is created between the brackets of the teeth that are adjacent to the joining point of the two wires, making the arch-wire unusable because this is an unwanted effect in orthodontic treatments.

For joining two wires to each other so that their central axes coincide (i.e., so that the wires are on the same horizontal, sagittal and frontal planes, i.e., are concentric), connectors of a known type have been used in the past but however they still have drawbacks.

US 2003/0073052A1 is also known, which describes an orthodontic arch-wire provided in three parts, in which the end of the two lateral parts is bent at 90° and a loop is obtained, on the front of which a hollow connector is soldered or crimped frontally and has a parallelepipedal or tubular shape with the axis directed at right angles to the arch-wire.

The upward-folded end of the central part is inserted within the connector; connection occurs by crimping, therefore without performing soldering.

In some illustrated variations, the connector is axially aligned with the lateral part of the arch-wire.

The use of conventional wire crimping does not ensure the perfect alignment of the three parts of the arch-wire in the three spatial planes (horizontal, sagittal, frontal). Furthermore, the use of conventional wire crimping does not ensure the maintenance of the alignment of the three segments of the arch-wire during the clinical use.

Since wires having a rectangular or square cross-section are often used, it is important that the mutual alignment of the two wires is such that said wires lie on the same horizontal, sagittal and also frontal planes, without variations in level.

Moreover, if the wires are not mutually aligned in the direction of rotation about the long axis of the orthodontic wire (or arch-wire), i.e., in the third order according to the orthodontic jargon, an unwanted torque is created on the brackets of the teeth that are contiguous to the joint (see FIG. 10).

The connector, therefore, also has the purpose of aligning the wires around their longitudinal axis (third order in orthodontic jargon), as shown in FIG. 11.

US 2003/0073052A1 also describes some variations in which the connector is axially aligned with the lateral part of the arch-wire: this solution, too, has drawbacks, since a slight axial offset of the connector entails an equal axial offset of the central part relative to the lateral part of the arch-wire.

US 2003/0073052A1 also describes some variations in which the connector is arranged at right angles to the lateral part of the arch-wire: this solution, too, has drawbacks, since a slight axial offset or inclination of the connector entails the arrangement of the central part of the arch-wire on a plane that is different from the plane of arrangement of the lateral parts.

Similar problems of axial misalignment or offset of planes of arrangement are observed if the connector of US 2003/0073052A1 is crimped directly onto two ends of the parts that have been arranged mutually adjacent beforehand, both when the ends are arranged on a plane that is perpendicular to the lateral and central parts and when they are on planes that are offset and then superimposed.

In the specific case of US 2003/0073052A1, a further drawback is also observed: for providing a strong joint, the two wires had to enter the connectors over a long extent, with the consequence that the connectors were extremely long, so that it was then difficult to position them between the brackets of contiguous teeth.

It is noted that the mesio-distal space between one bracket and the other is very small, in the order of 3-4 mm.

The described background art further has the drawback of requiring long times for the assembly of the final orthodontic arch-wire one wishes to obtain, increasing production costs and costs for the end user.

### SUMMARY OF THE INVENTION

The aim of the present invention is therefore to solve the described technical problems, eliminating the drawbacks of the cited background art and thus providing a connector that is capable of joining two wires or arch-wires so that they have the same central axis, i.e., they are concentric and therefore lie on the same plane, without differences in level in any of the three spatial planes, and so that the two wires or arch-wires enter the connector exactly by the desired extent.

Within this aim, an object of the invention is to provide a connector that has very small dimensions, so that it is easily accommodated in the small space that exists between the brackets of contiguous teeth.

Another object of the invention is to allow ensuring a very strong joint for the wires by means of the connector that at the same time has minimal space occupation.

Another object of the invention is to provide a connector that allows time saving during soldering or welding, thus reducing production costs.

Another object of the invention is to obtain a connector that is structurally simple, can be applied quickly and easily to assemble the arch-wire, has low manufacturing costs and can be provided by means of usual known systems.

This aim and these objects, as well as others that will become more apparent hereinafter, are achieved by a connector for orthodontic wires or arch-wires composed of two lateral parts and a central part, characterized in that it comprises a body that has one or two axial seats, each for an end of said wires that can be inserted therein, said one or two seats being divided by a partition that protrudes inside said body, grip means for an elastically deformable element being able to be associated with said body.

Advantageously, the body can have at least one access opening for the partition and/or for the one or two seats, the opening being obtainable in the upper wall and/or in the lower wall and/or in the vestibular wall and/or lingual wall.

### BRIEF DESCRIPTION OF THE DRAWINGS

Further characteristics and advantages of the invention will become more apparent from the detailed description of a particular but not exclusive embodiment, illustrated by way of non-limiting example in the accompanying drawings, wherein:

FIG. 1 is a lateral perspective view of the invention;

FIG. 2 is a view, similar to the preceding one, of the invention with the wires inserted;

FIG. 3 is a top view of the invention;

FIG. 4 is a view of the invention from the vestibular side;

FIG. 5 is a front view of the invention;

FIG. 6 is a sectional view, along the anteroposterior plane of the connector with the wires inserted;

FIG. 7 is a bottom view of the invention, in which an opening for soldering or welding is provided in the lower wall;

FIG. 8 is a bottom view of the invention with the wires inserted and with an opening provided in the lower wall;

FIG. 9 is a sectional view of the invention, along the horizontal plane, with the wires inserted;

FIG. 10 is a view of two ends of the wires that are not aligned in the direction of rotation about the longitudinal axis of the wire, i.e., in the third order according to orthodontics terminology;

FIG. 11 is a view of the ends of two wires which are aligned in the direction of rotation about the longitudinal axis of the wire;

FIG. 12 is a top view of the connector with the wires inserted;

FIG. 13 is a top view of the upper wall of the connector in which an opening is provided;

FIG. 14 is a view of any wall of the connector in which two distinct openings are provided.

### DESCRIPTION OF THE PREFERRED EMBODIMENTS

In the exemplary embodiments that follow, individual characteristics, given in relation to specific examples, may actually be interchanged with other different characteristics that exist in other exemplary embodiments.

With reference to the figures, the numeral 1 designates a connector for orthodontic wires or arch-wires 2 composed of two lateral parts 3a, 3b and a central part 4; said wires have a preferably rectangular cross-section.

Advantageously, the central part 4 has a larger cross-section than the lateral parts 3a, 3b.

Moreover, advantageously the central part 4 is more rigid than the lateral parts 3a, 3b.

The connector has a very small mesio-distal extension, comprised for example between 2 and 3 millimeters, preferably 2.5 mm, so that it can be easily positioned between the brackets of contiguous teeth.

The connector 1 is constituted by a body 5 that is shaped preferably but not necessarily like a parallelepiped and whose upper surface 6 and lower surface 7 have a shape that in plan view is preferably but not necessarily rectangular.

One or two seats 8, 8a, 8b are provided axially to the body 5 along the entire depth of said body 5 and have a cross-section that is preferably shaped complementary to the cross-section of the orthodontic wires 2 that constitute one of the lateral parts 3a, 3b and the central part 4.

Advantageously the shape of the seat or seats 8, 8a, 8b can be complementary to the shape of the orthodontic wires that constitute one of the lateral parts and the central part.

However, the cross-sectional shape of the seat or seats 8, 8a, 8b can also be different from the rectangular one.

At the ends of the body 5 in which said seat or seats 8, 8a, 8b is or are provided, it is possible to insert the end 10a, 10b of one of the orthodontic wires that constitute one of the lateral parts and the central part.

The seat or seats 8, 8a, 8b is or are divided by a partition 11 that has a mesio-distal thickness of substantially 0.2-0.3 mm and protrudes inside the body 5 starting substantially from the central region of the upper surface 6 or of the lower surface 7 or of the vestibular surface 13 or of the lingual surface 14.

The height of the partition 11 totally or partially affects the height of the seat or seats 8, 8a, 8b.

The connector has a very small mesio-distal extension, preferably 2.5 mm, since the brackets of contiguous teeth have a mutual distance in the order of 3-4 mm. If we subtract from 2.5 mm the thickness of 0.3 mm of the central partition and divide it by two, we find that the depth to which each wire enters the corresponding seat is substantially 1.1 mm.

The presence of the partition 11 therefore allows both wires to enter the corresponding seat exactly for a selected extent, and this allows optimum soldering, easily and quickly.

The partition 11 further acts as a stop, so that during soldering the wires always enter the seat exactly for the desired extent, for example 1.1 mm, which is the correct distance in order to obtain a strong soldering which at the same time has minimal space occupation.

All this allows time saving during soldering, thus reducing manufacturing costs; moreover, it is possible to provide higher repeatability to the quality of the soldering, due to the fact that the wires always enter the seats provided in the body 5 exactly for the same extent during the assembling and soldering process of the arch-wire.

Moreover, the partition 11 becomes a useful wall for mutually soldering the connector and the wires, both during braze welding or during laser welding.

Without the partition 11, the wires would be welded to only four walls (the upper one, the lower one, the vestibular one and the lingual one), whereas in the illustrated solution the wires are welded to five walls (i.e. the four walls 6, 7, 13, 14 of the connector, plus the partition 11), thus increasing the strength of the weld, which, as we note, has a very small extension indeed in order to minimize the space occupation of said connector.

Advantageously, the body 5 can have at least one opening 12 for access to said partition 11 and/or for said seat or two seats 8, 8a, 8b, said opening 12 being obtainable in the upper wall 6 and/or lower wall 7 and/or vestibular wall 13 and/or lingual wall 14.

The shape and the dimensions of said opening 12 can be the most disparate depending on specific requirements.

Furthermore, the partition 11 might optionally protrude from said opening 12.

There might also be more than one opening 12; in any case, once again, the partition 11 acts as a stop, in order to obtain the entrance of the wires for a desired extent.

At the vestibular wall 13 of the body 5 or at the lingual surface 14 or at the upper surface 6 or lower surface 7 of the body 5 it is possible to associate, for example by soldering, grip means such as a hook 15 for an elastically deformable element such as an elastic for orthodontic appliances.

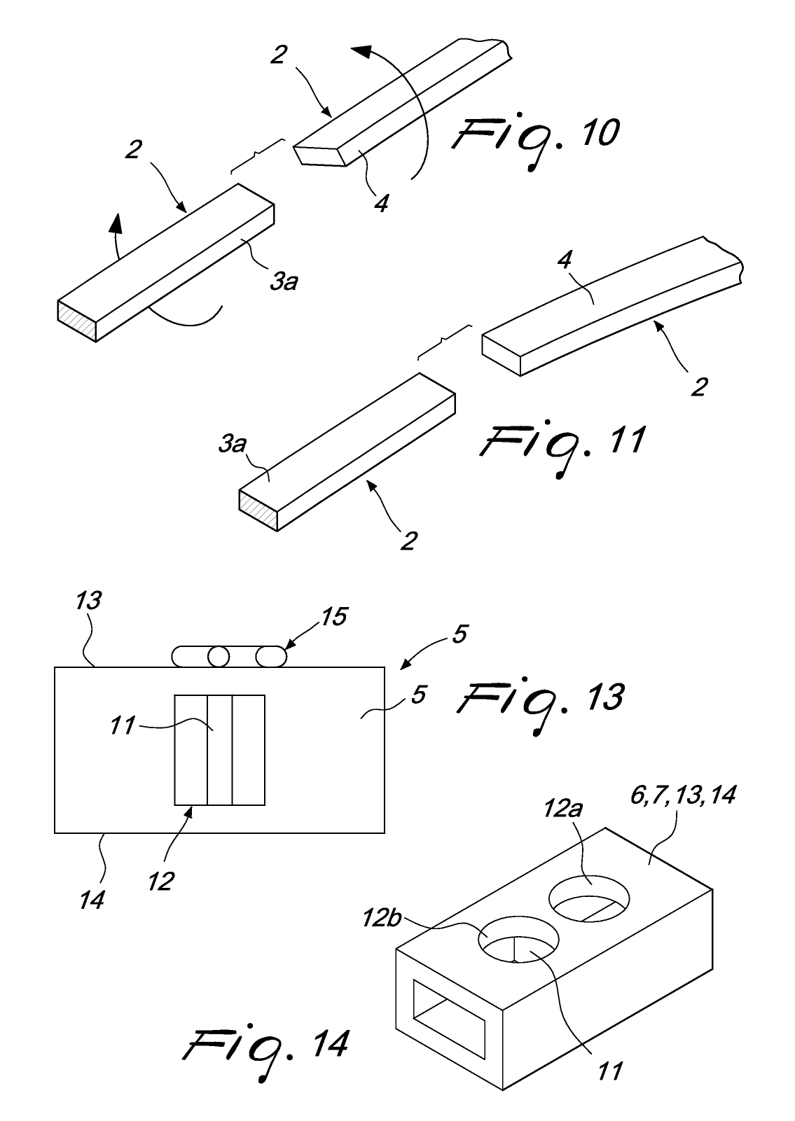

FIG. 13 is a view of a solution in which the opening 12 is obtained in the upper wall 6.

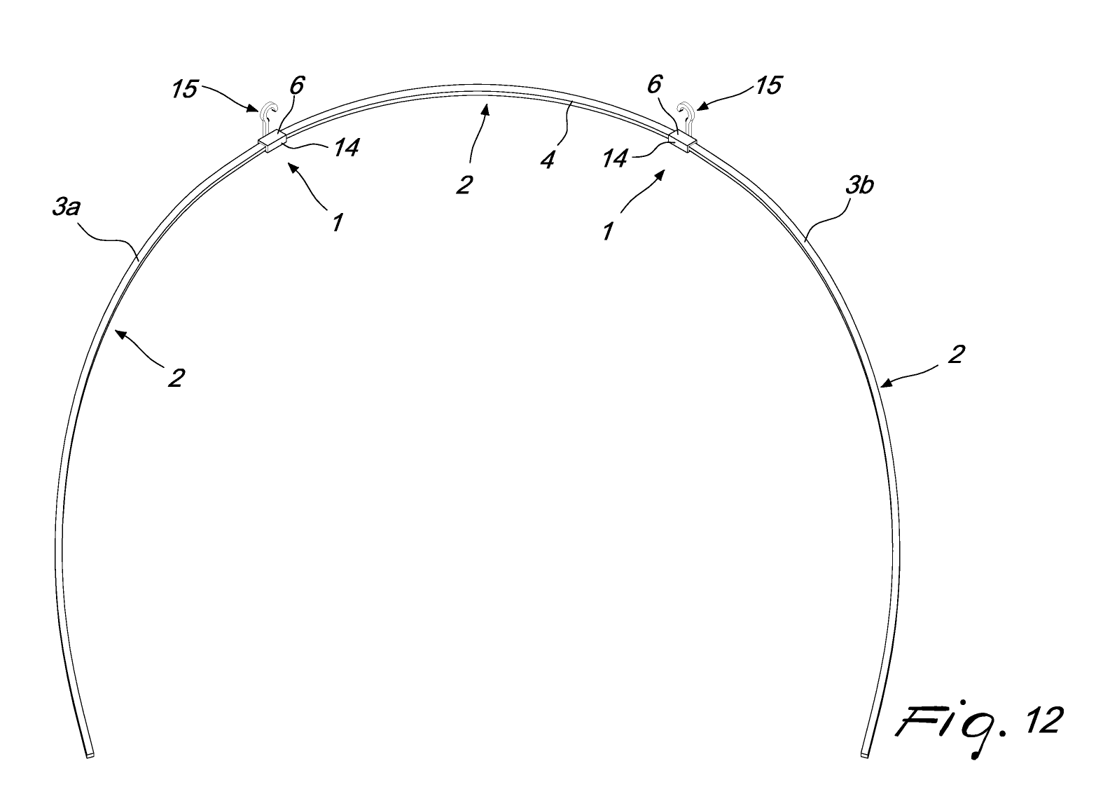

FIG. 14 is a view of a solution in which two openings, designated by the numerals 12a, 12b are provided at any wall of the body 5 and are provided so as to be mutually adjacent in a region that in turn is adjacent to the partition 11.

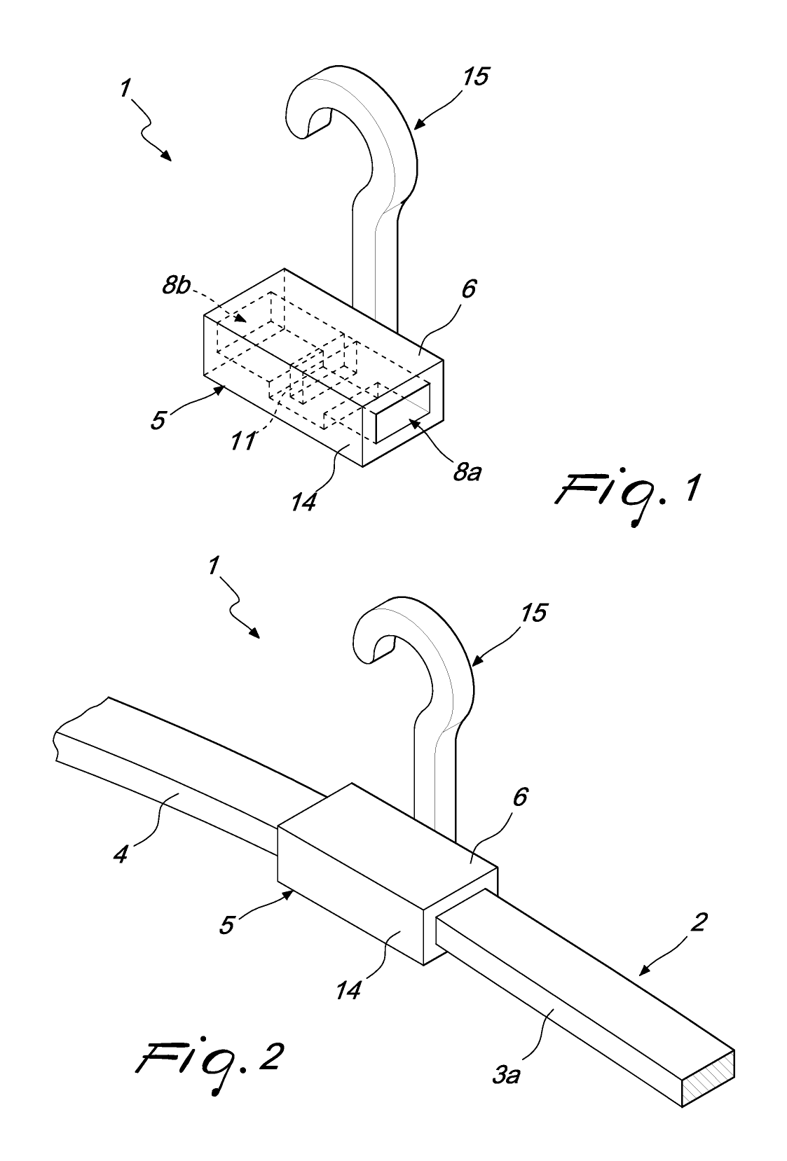

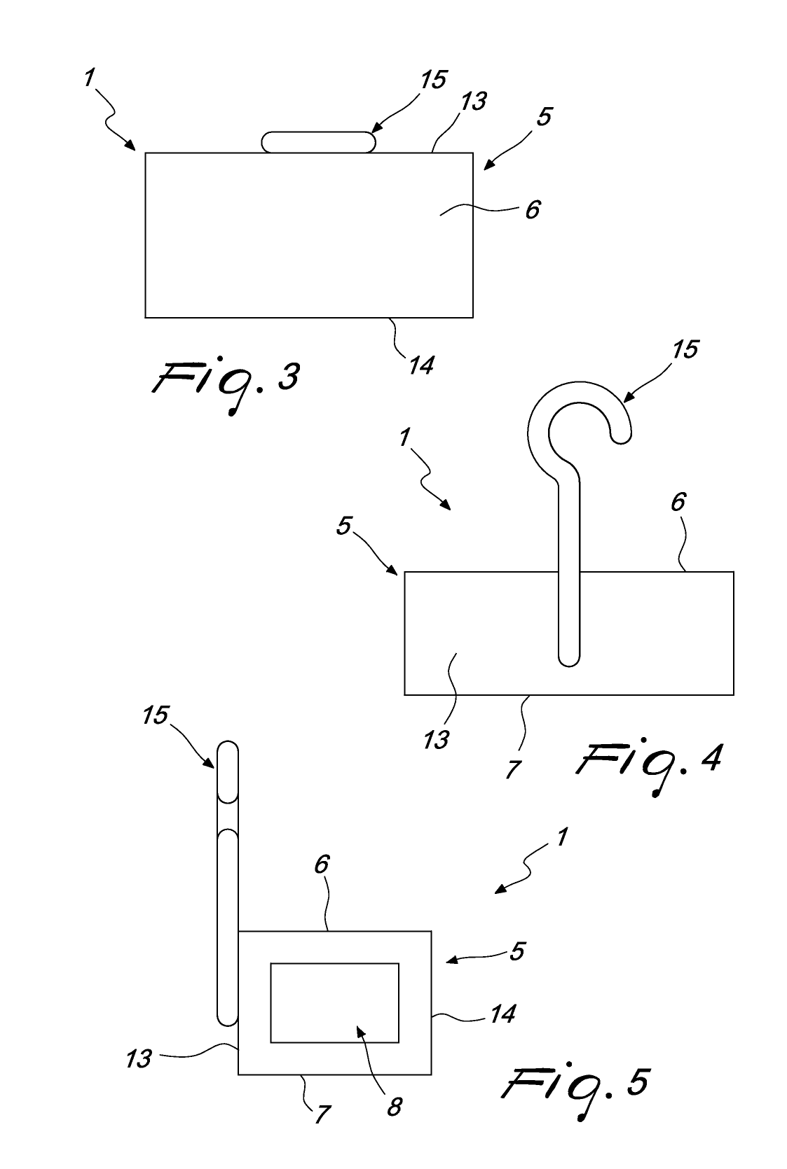

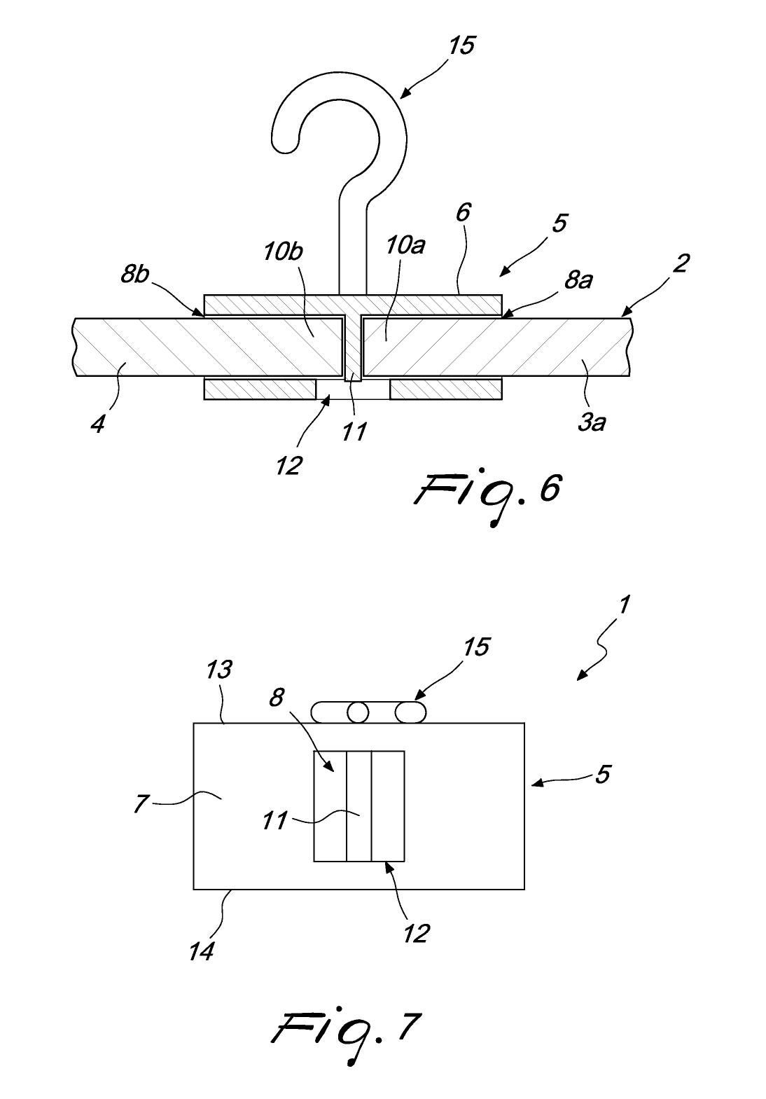

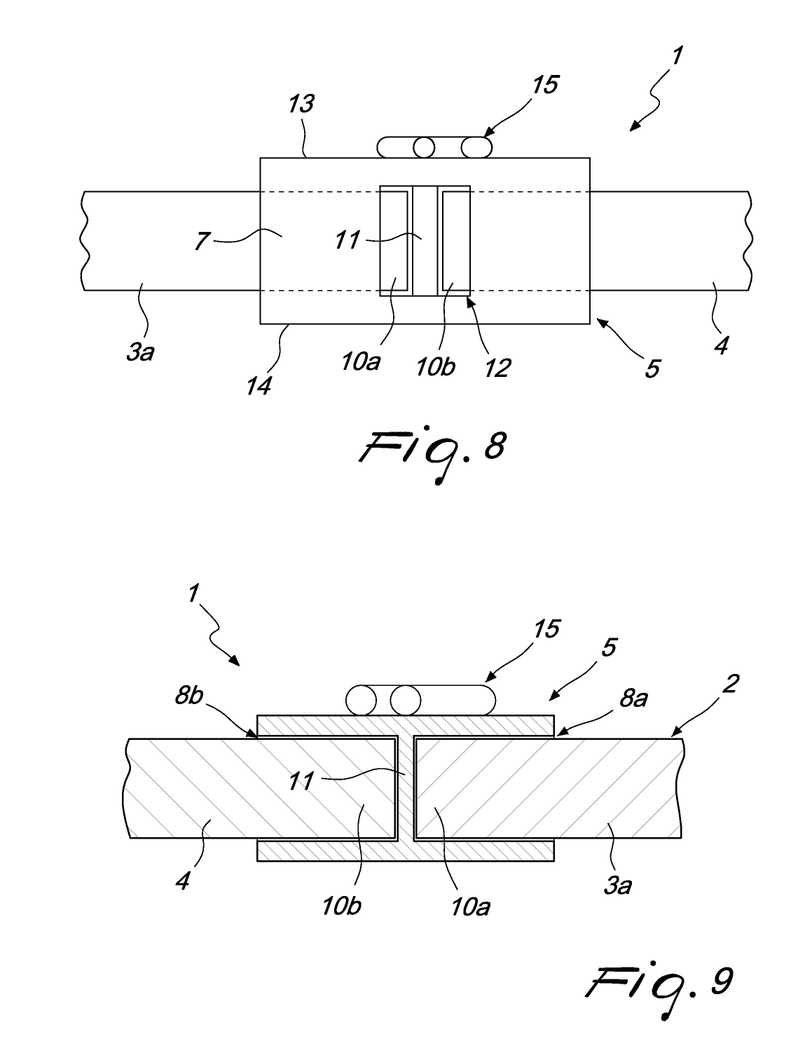

The openings 12, 12a, 12b (see FIGS. 1, 6, 7, 8, 13, 14) have the purpose to provide an access to allow making a soldering between the connector and the orthodontic wires (or arch-wires) inserted therein.

It has thus been found that the invention has achieved the intended aim and objects, a connector having been obtained which is capable of joining two wires or arch-wires so that they have the same central axis, i.e., are concentric and therefore lie on the same plane, without differences in level in any of the three spatial planes, said wires or arch-wires penetrating the connector exactly by the desired extent.

The invention further allows ensuring a very strong joint for the wire, and at the same time has minimal space occupation, the connection allowing the saving of time during soldering, thus reducing manufacturing costs, the quality of the soldering being finally repeatable over time.

The materials used, as well as the dimensions that constitute the individual components of the invention, may of course be more pertinent to the specific requirements.

The various means for performing certain different functions need not to certainly coexist only in the illustrated embodiment but can be present per se in many embodiments, including embodiments that are not illustrated.

The characteristics indicated as advantageous, convenient or the like may also be omitted or be replaced by equivalents.

The disclosures in Italian Utility Model Application No. TV2012U000059 from which this application claims priority are incorporated herein by reference.

What is claimed is:

1. A connector for orthodontic arch-wires composed of two lateral parts and a central part, comprising a body that has one or two axial seats, each for an end of said wires that can be inserted therein, said one or two seats being divided by a partition that protrudes inside said body, grip means for an elastically deformable element being able to be associated to said body.

2. The connector according to claim 1, wherein said body has at least one access opening for said partition and/or for said one or two seats, said opening being obtainable in the upper wall and/or lower wall and/or vestibular wall and/or lingual wall.

3. The connector according to claim 1, wherein said one or two axial seats are provided axially to said body, along its entire depth, and have a cross-section that is shaped complementary to the cross-section of said orthodontic wires that constitute one of the lateral parts and the central part.

4. The connector according to claim 2, wherein at the ends of said body on which said one or two seats are provided it is possible to insert an end of one of said orthodontic wires that constitute one of the lateral parts and the central part, said one or two seats being divided by said partition.

5. The connector according to claim 2, wherein said partition protrudes inside said body substantially starting from the central region of the upper wall or of the lower wall or of the vestibular wall or of the lingual wall.

6. The connector according to claim 1, wherein the height of said partition at least partially affects the height of said one or two seats.

7. The connector according to claim 1, wherein said partition allows both of said wires to enter the corresponding seat of said connector exactly for a desired extent.

8. The connector according to claim 1, wherein said partition acts as a stop for said wires, so that they always enter said one or two seats exactly for the desired extent.

9. The connector according to claim 1, wherein said partition constitutes a useful wall for soldering between said connector and said wires.

10. The connector according to claim 1, wherein said partition has a height that is equal to, or lower than, the height of said one or two seats.

11. The connector according to claim 2, wherein said partition has such a height as to at least partially affect the thickness of said upper and/or lower wall and/or vestibular wall and/or lingual wall in which said opening is defined.

12. The connector according to claim 2, wherein grip means, such as a hook for an elastically deformable element such as an elastic for orthodontic appliances, can be associated at the vestibular wall or at the lingual wall or at the upper wall or at the lower wall of said body.

13. The connector according to claim 1, wherein in any wall of said body there are two openings provided so as to be mutually adjacent in a region that in turn is adjacent to said partition.

14. The connector according to claim 2, wherein at the vestibular wall of said body or at the lingual surface or upper surface or lower surface of said body a hook is associated for an elastically deformable element such as an elastic for orthodontic appliances.

15. The connector according to claim 1, wherein said body has a parallelepipedal or tubular shape.

16. The connector according to claim 13 wherein said openings have a polygonal, preferably circular, cross-section shape.
